(19) United States
(12) Patent Application Publication
(10) Pub. No.: US 2010/0250646 A1
(43) Pub. Date: Sep. 30, 2010

(54) MECHANISM FOR GEO DISTRIBUTING APPLICATION DATA

(75) Inventors: John D. Dunagan, Bellevue, WA (US); Alastair Wolman, Seattle, WA (US); Atul Adya, Redmond, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/410,552

(22) Filed: Mar. 25, 2009

(51) Int. Cl. G06F 15/173; G06F 15/16

(52) U.S. Cl. 709/203; 709/226

(57) ABSTRACT

The claimed subject matter provides systems and methods that effectuates inter-datacenter resource interchange. The system can include devices that receive a resource request from a client component, forward the resource request to a management component that returns a cluster identity associated with a remote datacenter, the resource request and the cluster identity combined and dispatched to the remote datacenter via an inter-cluster gateway component for subsequent fulfillment by a remote server associated the remote datacenter.

### BACKGROUND

In recent years there has been a massive push in the computer industry to build enormous datacenters. These datacenters are typically employed to deliver a class of compelling and commercially important applications, such as instant messaging, social networking, and web search. Moreover, scale-out datacenter applications are of enormous commercial interest, yet they can be frustratingly hard to build. A common pattern in building such datacenter applications is to split functionality into stateless frontend servers, soft-state middle tier servers containing complex application logic, and backend storage systems. Nevertheless, to date much prior work has been focused on scalable backend storage systems.

The subject matter as claimed is directed toward resolving or at the very least mitigating, one or all the problems elucidated above.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

The claimed subject matter relates to systems and methods that effectuate inter-datacenter resource interchange. The systems can include devices that receive a resource request from a client component, forward the resource request to a management component that returns a cluster identity associated with a remote datacenter, the resource request and the cluster identity combined and dispatched to the remote datacenter via an inter-cluster gateway component for subsequent fulfillment by a remote server associated the remote datacenter.

To the accomplishment of the foregoing and related ends, certain illustrative aspects of the disclosed and claimed subject matter are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a machine-implemented system that effectuates and/or facilitates inter-datacenter resource interchange in accordance with an aspect of the claimed subject matter.

FIG. 2 depicts a further machine-implemented system that effectuates and/or facilitates inter-datacenter resource interchange in accordance with an aspect of the claimed subject matter.

FIG. 3 provides a more detailed depiction of a machine-implemented system that effectuates and/or facilitates inter-datacenter resource interchange in accordance with an aspect of the claimed subject matter.

FIG. 4 provides depiction of a machine-implemented system that effectuates and/or facilitates inter-datacenter resource interchange in accordance with a further aspect of the claimed subject matter.

FIG. 5 illustrates a system implemented on a machine that effectuates and/or facilitates inter-datacenter resource interchange in accordance with a further aspect of the claimed subject matter.

FIG. 6 provides a further depiction of a machine implemented system that effectuates and/or facilitates inter-datacenter resource interchange in accordance with a further aspect of the claimed subject matter.

FIG. 7 illustrates a flow diagram of a machine implemented methodology that effectuates and/or facilitates inter-datacenter resource interchange in accordance with a further aspect of the claimed subject matter.

FIG. 8 illustrates a further flow diagram of a machine implemented methodology that effectuates and/or facilitates inter-datacenter resource interchange in accordance with a further aspect of the claimed subject matter.

FIG. 9 illustrates a block diagram of a computer operable to execute the disclosed system in accordance with an aspect of the claimed subject matter.

FIG. 10 illustrates a schematic block diagram of an illustrative computing environment for processing the disclosed architecture in accordance with another aspect.

### DETAILED DESCRIPTION

The subject matter as claimed is now described with reference to the drawings, wherein like reference numerals are used to refer to like elements throughout. In the following description, for purposes of explanation, numerous specific details are set forth in order to provide a thorough understanding thereof. It may be evident, however, that the claimed subject matter can be practiced without these specific details. In other instances, well-known structures and devices are shown in block diagram form in order to facilitate a description thereof.

At the outset it should be noted, without limitation or loss of generality, that the term “cluster” as employed herein relates to a set of machines in a datacenter that are a manageable unit of scaling out operations against resources. Typically, a cluster can contain a few hundred machines. Moreover, the term “datacenter” as utilized in the following discussion relates to a collection of nodes and clusters typically co-located within the same physical environment. In general, datacenters are distinct from clusters in that communication latency between datacenters can be significantly higher.

As multiple geographically dispersed clusters and datacenters are added to data synchronization systems that allow files, folders, and other data to be shared and synchronized across multiple devices, services will need the ability to locate the correct datacenter and cluster for a particular resource—in that cluster, they can then ask for the particular machine that owns the resource. Furthermore, certain services can need to register for recovery notifications across clusters. In order to accommodate these requirements, the claimed subject matter, through a Partitioning and Recovery Service (PRS) provides the mechanisms to provide full support for placing, migrating, looking up, and recovering soft-state entities, e.g., support lookups and recovery notifications across clusters while providing a unified name space for soft-state services.

The Partitioning and Recovery Service (PRS) allows hosts to lookup a resource key and obtain the cluster or local server where that resource is being handled. In order to perform this operation, the Partitioning and Recovery Service's (PRS's) lookup algorithm is structured into two acts—first, locate the cluster and, second, locate the actual server in the cluster. These two mechanisms have been separated because they can have very different characteristics and requirements. In particular, inter-cluster lookup can require traversing inter-datacenter (perhaps trans-oceanic) links, while intra-cluster lookup is generally confined within a local area network.

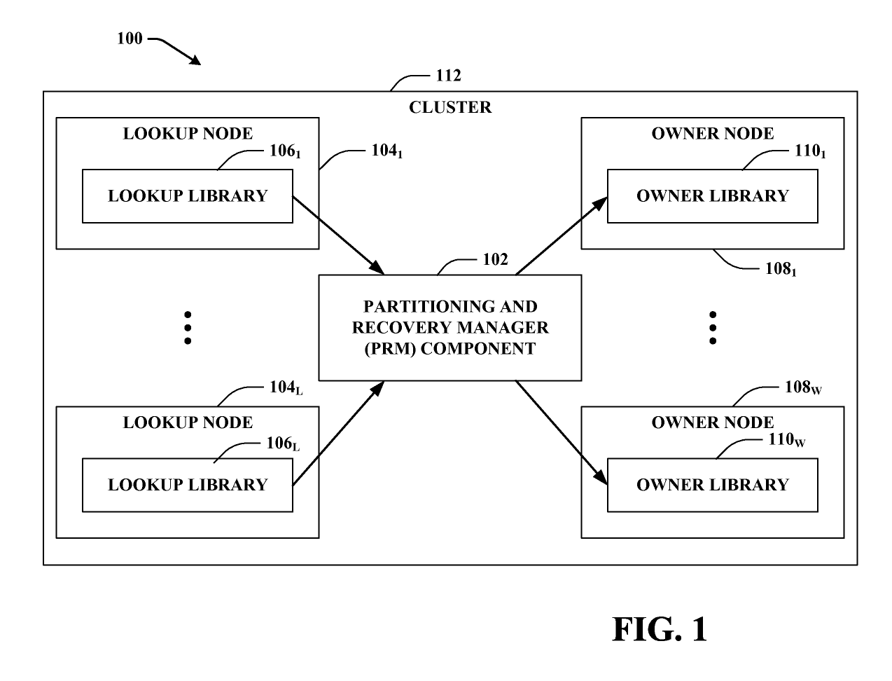

FIG. 1 provides a high-level overview 100 of the Partitioning and Recovery Service (PRS) design. As illustrated, cluster 112 can include a partitioning and recovery manager (PRM) component 102 that typically can be part of every cluster. Partitioning and recovery manager (PRM) component 102 can be the authority for distributing resources to owner nodes (e.g., owner nodes 108₁, . . . , 108_{W}) in the cluster and answering lookup queries for those resources. Additionally as depicted, cluster 112 can also include lookup nodes (e.g., lookup nodes 104₁, . . . , 104_{L}) that can be the source of resource requests to partitioning and recovery manager (PRM) component 102. Associated with each owner node 108₁, . . . , 108_{W} can be an owner library (e.g., owner library 110₁, . . . , 110_{W}), and similarly, confederated with each lookup node 104₁, . . . , 104_{L} can be a lookup library (e.g., lookup library 106₁, . . . , 106_{L}). Instances of owner library 110₁, . . . , 110_{W} and lookup library 106₁, . . . , 106_{L} can be instances of cached or pre-fetched information, but generally in all instances where there is a conflict, partitioning and recovery manager (PRM) component 102 is always the authority.

Partitioning and recovery manager (PRM) component 102 can also be responsible for informing lookup libraries (e.g., lookup library 106₁, . . . , 106_{L} associated with respective lookup node 104₁, . . . , 104_{L}) which remote or destination partitioning and recovery manager (PRM) component to contact so that inter-cluster (e.g., between cluster 112 and one or more other geographically dispersed clusters) lookups can be possible. Generally, owner nodes 108₁, . . . , 108_{W} that want to host resources can typically link with the owner library (e.g., owner library 110₁, . . . , 110_{W}) whereas nodes that want to perform lookup can link with the lookup library (e.g., lookup library 106₁, . . . , 106_{L}). As will be appreciated by those moderately skilled in this field of endeavor, no end-service typically interacts directly with partitioning and recovery manager (PRM) component 102.

It should be noted, without limitation or loss of generality, that partitioning and recovery manager (PRM) component 102, lookup nodes 104₁, . . . , 104_{L}, and owner nodes 108₁, . . . , 108_{W}, can be implemented entirely in hardware and/or a combination of hardware and/or software in execution. Further partitioning and recovery manager (PRM) component 102, lookup nodes 104₁, . . . , 104_{L}, and owner nodes 108₁, . . . , 108_{W}, can be incorporated within and/or associated with other compatible components. Additionally, one or more of partitioning and recovery manager (PRM) component 102, lookup nodes 104₁, . . . , 104_{L}, and/or owner nodes 108₁, . . . , 108_{W} can be, but is not limited to, any type of machine that includes a processor and/or is capable of effective communication with a network topology. Illustrative machines upon which partitioning and recovery manager (PRM) component 102, lookup nodes 104₁, . . . , 104_{L}, and owner nodes 108₁, . . . , 108_{W} can be effectuated can include desktop computers, server class computing devices, cell phones, smart phones, laptop computers, notebook computers, Tablet PCs, consumer and/or industrial devices and/or appliances, hand-held devices, personal digital assistants, multimedia Internet mobile phones, multimedia players, and the like.

An illustrative network topology can include any viable communication and/or broadcast technology, for example, wired and/or wireless modalities and/or technologies can be utilized to effectuate the claimed subject matter. Moreover, a network topology can include utilization of Personal Area Networks (PANs), Local Area Networks (LANs), Campus Area Networks (CANs), Metropolitan Area Networks (MANs), extranets, intranets, the Internet, Wide Area Networks (WANs)—both centralized and/or distributed—and/or any combination, permutation, and/or aggregation thereof. Additionally, the network topology can include or encompass communications or interchange utilizing Near-Field Communications (NFC) and/or communications utilizing electrical conductance through the human skin, for example.

Further it should be noted, again without limitation or loss of generality, that owner libraries (e.g., owner library 110₁, . . . , 110_{W}) associated with each owner node (e.g., owner nodes 108₁, . . . , 108_{W}) and lookup libraries (e.g., lookup library 106₁, . . . , 106_{L}) affiliated with each lookup node (e.g., lookup nodes 104₁, . . . , 104_{L}) can be, for example, persisted on volatile memory or non-volatile memory, or can include utilization of both volatile and non-volatile memory. By way of illustration, and not limitation, non-volatile memory can include read-only memory (ROM), programmable read only memory (PROM), electrically programmable read only memory (EPROM), electrically erasable programmable read only memory (EEPROM), or flash memory. Volatile memory can include random access memory (RAM), which can act as external cache memory. By way of illustration rather than limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink® DRAM (SLDRAM), Rambus® direct RAM (RDRAM), direct Rambus® dynamic RAM (DRDRAM) and Rambus® dynamic RAM (RDRAM). Accordingly, the owner libraries (e.g., owner library 110₁, . . . , 110_{W}) and/or the lookup libraries (e.g., lookup library 106₁, . . . , 106_{L}) of the subject systems and methods are intended to employ, without being limited to, these and any other suitable types of memory. In addition, it is to be appreciated that the owner libraries (e.g., owner library 110₁, . . . , 110_{W}) and/or lookup libraries (e.g., lookup library 106₁, . . . , 106_{L}) can be implemented on a server, a database, a hard drive, and the like.

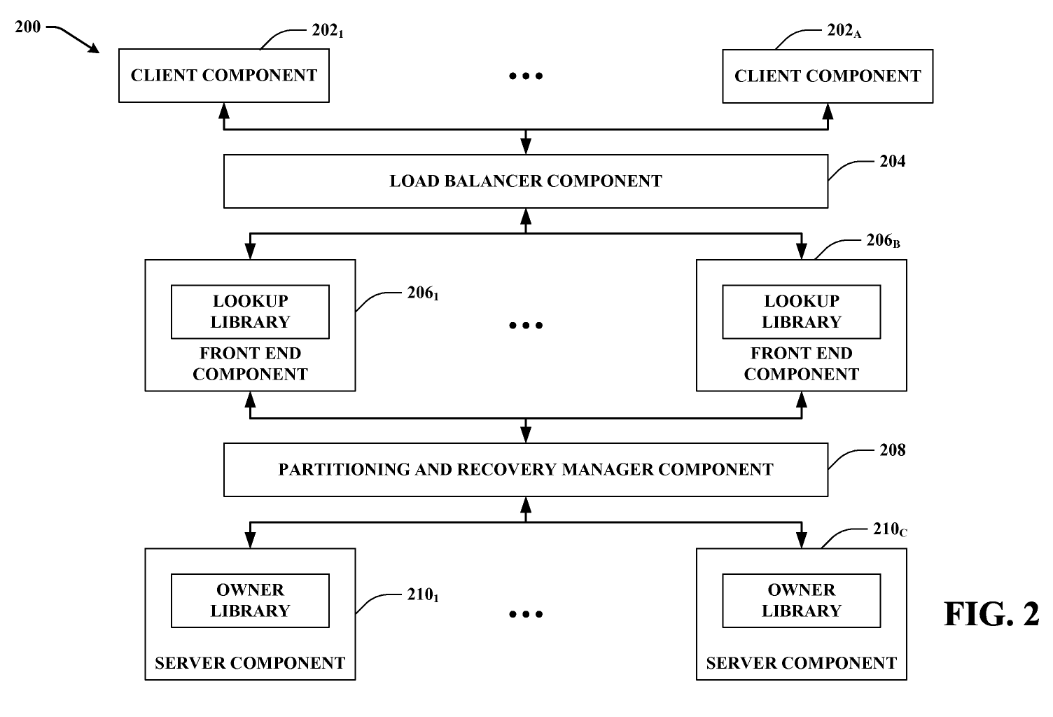

FIG. 2 illustrates an end-to-end use of the Partitioning and Recovery Service (PRS) 200 by a device connectivity service in a single cluster (e.g., cluster 112). As depicted, the cluster can include a plurality of client components 202₁, . . . , 202_{A} that can initiate a request for one or more resources resident or extant within the cluster. Client components 202₁, . . . , 202_{A}, via a network topology, can be in continuous and/or operative or sporadic and/or intermittent communication with load balancer component 204 that can rapidly distribute requests for resources from client components 202₁, . . . , 202_{A} to multiple front end components 206₁, . . . , 206_{B}. Client components 202₁, . . . , 202_{A} can be implemented entirely in hardware and/or a combination of hardware and/or software in execution. Further, client components 202₁, . . . , 202_{A} can be incorporated within and/or associated with other compatible components. Additionally, client components 202₁, . . . , 202_{A} can be, but are not limited to, any type of machine that includes a processor and/or is capable of effective communication with a network topology. Illustrative machines that can comprise client components 202₁, . . . , 202_{A} can include desktop computers, server class computing devices, cell phones, smart phones, laptop computers, notebook computers, Tablet PCs, consumer and/or industrial devices and/or appliances, hand-held devices, personal digital assistants, multimedia Internet mobile phones, multimedia players, and the like.

Load balancer component 204, as the name suggests, rapidly distributes the incoming requests from the various client components 202₁, . . . , 202_{A} to ensure that no single front end component 206₁, . . . , 206_{B} is disproportionately targeted with making lookup calls to the partitioning and recovery manager component 208. Accordingly, load balancing component 204 can employ one or more load balancing techniques in order to smooth the flow and rapidly disseminate the requests from client components 202₁, . . . , 202_{A} to front end component 206₁, . . . , 206_{B}. Examples of such load balancing techniques or scheduling algorithms can include, without limitation, such techniques as round robin scheduling, deadline-monotonic priority assignment, highest response ratio next, rate-monotonic scheduling, proportional share scheduling, interval scheduling, etc. The facilities and functionalities of load balancer component 204, can be performed on, but is not limited to, any type of mechanism, machine, device, facility, and/or instrument that includes a processor and/or is capable of effective and/or operative communications with network topology. Mechanisms, machines, devices, facilities, and/or instruments that can comprise load balancer component 204 can include Tablet PC's, server class computing machines and/or databases, laptop computers, notebook computers, desktop computers, cell phones, smart phones, consumer appliances and/or instrumentation, industrial devices and/or components, hand-held devices, personal digital assistants, multimedia Internet enabled phones, multimedia players, and the like.

Front end components 206₁, . . . , 206_{B} can link the lookup libraries associated with each of the front end components 206₁, . . . , 206_{B} and make lookup calls to the partitioning and recovery manager component 208. Front end components 206₁, . . . , 206_{B}, like client components 202₁, . . . , 202_{A} and load balancer component 204, can be implemented entirely in hardware and/or as a combination of hardware and/or software in execution. Further, front end components 206₁, . . . , 206_{B}, can be, but are not limited to, any type of engine, machine, instrument of conversion, or mode of production that includes a processor and/or is capable of effective and/or operative communications with network topology. Illustrative instruments of conversion, modes of production, engines, mechanisms, devices, and/or machinery that can comprise and/or embody front end components 206₁, . . . , 206_{B} can include desktop computers, server class computing devices and/or databases, cell phones, smart phones, laptop computers, notebook computers, Tablet PCs, consumer and/or industrial devices and/or appliances and/or processes, hand-held devices, personal digital assistants, multimedia Internet enabled mobile phones, multimedia players, and the like.

Partitioning and recovery manager component 208, as has been outlined in connection with partitioning and recovery manager (PRM) component 102 above, can be the authority for distributing resources to server components 210₁, . . . , 210_{C} and answering lookup queries for those resources. Additionally, partitioning and recovery manager component 208 can be responsible for informing lookup libraries associated with respective front end components 206₁, . . . , 206_{B} which remote or destination partitioning and recovery manager (PRM) component in a geographically dispersed cluster to contact so that inter-cluster lookups can be effectuated.

Server components 210₁, . . . , 210_{C} can store resources, such as presence documents, that can on request be supplied to fulfill resource requests emanating from one or more client components 202₁, . . . , 202_{A}. Server components 210₁, . . . , 210_{C}, like client components 202₁, . . . , 202_{A}, load balancer component 204, front end components 206₁, . . . , 206_{B}, and partitioning and recovery manager component 208, can be can be any type of mechanism, machine, device, facility, and/or instrument such as embedded auto personal computers (AutoPCs), appropriately instrumented hand-held personal computers, Tablet PC's, laptop computers, notebook computers, cell phones, smart phones, portable consumer appliances and/or instrumentation, mobile industrial devices and/or components, hand-held devices, personal digital assistants, multimedia Internet enabled phones, multimedia players, server class computing environments, and the like.

It should be recognized under the foregoing operational rubric, without limitation or loss of generality, that when and if a server component (e.g., one or more of server components 210₁, . . . , 210_{C}) crashes, the lookup libraries associated with front end components 206₁, . . . , 206_{B} can issue notifications to calling code (e.g., resource requests emanating from one or more client components 202₁, . . . , 202_{A} requesting resources from the disabled server component) given that the overall Partitioning and Recovery Service (PRS) as effectuated by partitioning and recovery manager component 208 provides two guarantees: (i) at-most one owner guarantee: there is at most one owner node (e.g., server component 210) that owns or controls a particular resource at any given point in time; and (ii) recovery notifications guarantee: if an owner node (e.g., server component 210) crashes or loses resources (or part thereof), the lookup libraries associated with front end components 206₁, . . . , 206_{B}, will issue recovery notifications in a timely manner.

As will be appreciated by those of moderate skill in the art the subscripts A, B, C utilized in relation to the description of client components 202₁, . . . , 202_{A}, front end components 206₁, . . . , 206_{B}, and server components 210₁, . . . , 210_{C}, denote integers greater than zero, and are employed, for the most part, to connote a respective plurality of the aforementioned components.

The goal of the claimed subject matter is to effectively conjoin the functionalities and facilities included in lookup libraries associated with front end components in a first cluster with the functionalities and facilities included in lookup libraries affiliated with front end components in a second cluster, where the first and second clusters are distantly dispersed and are associated with respective geographically disparate datacenters. For instance, lookup libraries associated with front end components in a first cluster can be associated with a datacenter located in Salinas, Calif. whereas lookup libraries affiliated with front end components in a second cluster can be affiliated with a datacenter located in Ulan Bator, Mongolia.

Similarly, a further aim of the claimed subject matter is to also effectively associate the facilities and functionalities included in owner libraries associated with multiple server components that comprise a first cluster associated with a datacenter in a first geographical location with the functionalities and facilities included in owner libraries associated with multiple server components dispersed to form a second cluster associated with a datacenter situated in a second geographical location, where the first and second geographical locations are separated by distance and geography. For example, owner libraries associated with multiple server components included in a first cluster and associated with a datacenter in a first geographical location can be situated in Vancouver, British Columbia, and owner libraries associated with multiple server components included in a second cluster and affiliated with a datacenter in a second geographical location can be located in Utica, N.Y.

It should be noted, once again without limitation or loss of generality that the multiple server components and multiple front end components included in a cluster can also be geographically dispersed. Similarly, the aggregation of clusters to form datacenters can also include multiple clusters that in of themselves are situationally dispersed. For example, a first set of server and front end components can be located in East Cleveland, Ohio, a second set of server and front end components can be located in Xenia, Ohio, and a third set of server and front end components can be located in Macon, Ga., the first, second, and/or third set of server and front end components can be aggregated to form a first cluster. Further, other sets of server and front end components located in Troy, N.Y., Chicopee, Mass., and Blue Bell, Pa. respectively can form a second cluster. Such multiple clusters of geographically dispersed sets of server and front end components can be agglomerated to comprise a datacenter.

In view of the foregoing, the problem overcome by the claimed subject matter therefore, relates to the fact that a given front end and its associated lookup libraries can now be in one datacenter situated in Manaus, Brazil, for example, and it can need to communicate with a server component and its associated owner libraries, situated in Beijing, China to fulfill a resource request. Accordingly, the lookup libraries associated with the front end component situated in the datacenter in Manaus, Brazil needs to be informed that the server it wishes to communicate with is located in a datacenter in Beijing, China, for instance. Once the front end is aware of the fact that it and its associated lookup libraries need to be in communication, or commence data interchange, with a server component and its associated owner libraries situated in a geographically disparate trans-oceanic datacenter located in Beijing, China, the front end can determine how it should establish such a communications link.

There are a few different ways in which the front end component and its associated lookup libraries can handle the fact that a requested resource is being controlled or is owned by a server component situated in a geographically disparate location. In general lookups can be resolved to the cluster level or the owner level and calling services can have a number of options.

In the case where lookups are resolved to the cluster level, the lookup library can resolve the resources address's location only to the datacenter/cluster level. It is expected that either the client component (or the calling service) will then resolve the exact machine by calling the lookup function in the destination cluster. There are a number of choices how different services can effectuate cluster-level resolution. First, hypertext transfer protocol (HTTP) redirection can be employed. For example, if a front end and its associated lookup library is presented with a resource address, the front end can obtain the lookup result from a library associated with the partitioning and recover manager (e.g., partitioning and recovery manager 208) using a lookup call and supplies the result to a locator service library. The locator service can then return the domain name system (DNS) name of the cluster at which point the calling client component can be redirected to the destination cluster where a further lookup can be performed to identify the name of the machine handling or controlling the resource being requested by the calling or requesting client component.

Further, a service-specific redirection mechanism can be employed wherein a front end component can locate the datacenter and cluster of the resource and thereafter perform a service-specific action such as, for example, translating a location-independent URL for the resource to a location-dependent URL for the resource.

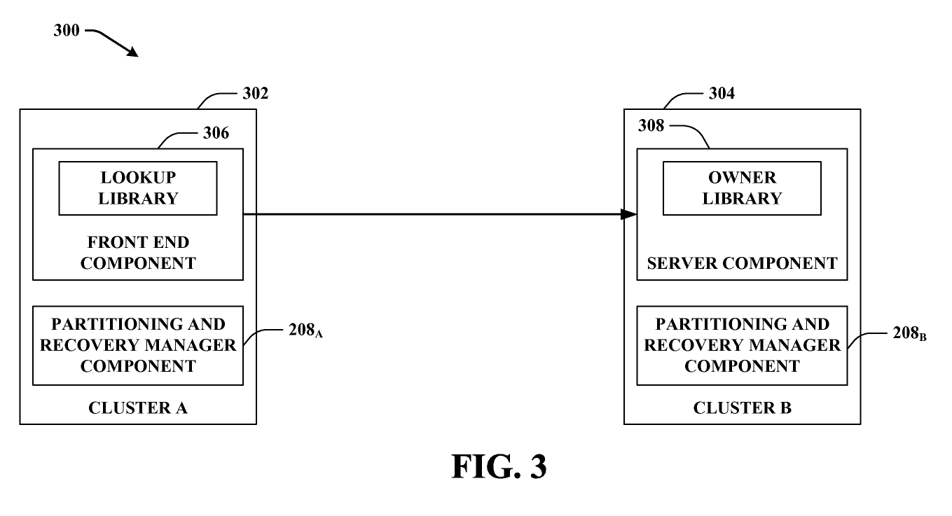

FIG. 3 illustrates a system 300 that can be employed to effectuate resource interchange between a front end component included in a first cluster and associated with a first datacenter situated in a first geographical location and a server component included in a second cluster and associated with a second datacenter situated in a second geographical location, wherein each of the first and second geographical locations are geographically remote from one another. As depicted, system 300 can include cluster A 302 that is associated with a datacenter situated in a first geographic location, for example, Athens, Greece, and cluster B 304 that is associated with a data center situated in a second geographic location, for instance, Broken Hill, Australia. As has been elucidated above, each of cluster A 302 and cluster B 304 can be but one cluster of many clusters associated with each respective datacenter situated in the first geographic location and the second geographic location.

Cluster A 302 can include front end component 306 together with its associated lookup libraries and partitioning and recovery manager component 208_{A}, and cluster B 304 can include server component 308 together with its affiliated owner libraries and partitioning and recovery manager component 208_{B}. As stated above, partitioning and recovery manager components 208_{A} and 208_{B} can be a component in every cluster and is typically the authority for distributing resources from front end component 306 to server component 308. Since the general facilities and functionalities of the partitioning and recovery manager component has been set forth above, a detailed description of such attributes has been omitted for the sake of prolixity and to avoid needless repetition.

As illustrated in FIG. 3, front end component 306 on receipt of resource requests conveyed from a load balancer component (e.g., 204) and emanating from one or more client components (e.g., client components 202₁, . . . , 202_{A}) can utilize its associated lookup libraries and send the resource request directly to server component 308 located in a destination datacenter situated in a geographically disparate location for fulfillment of the resource request (e.g., from owner libraries associated with server component 308). While this approach is plausible for the most part, since both the server component and front end components can be configured and/or tuned for inter-cluster intra-datacenter communications (e.g., front end and server components are tuned for instantaneous or near instantaneous response times within clusters associated with a specific datacenter-communications latency minimal response time tuning) the direct approach can fail where inter-datacenter communications are to be effectuated since communication latency with respect to inter-datacenter communications can be measurably significant.

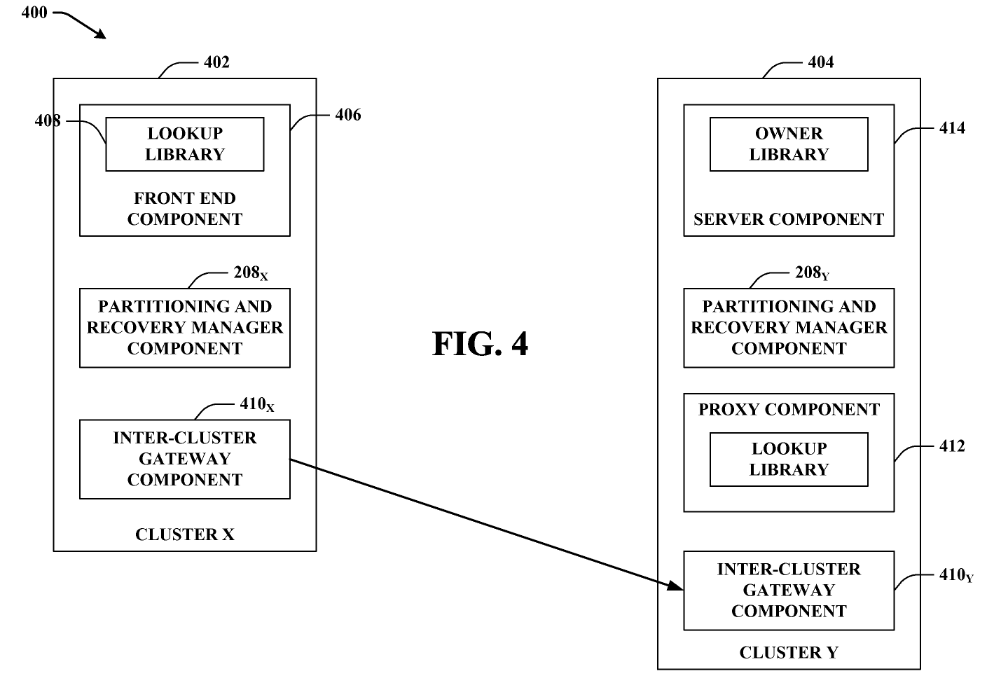

FIG. 4 provides illustration of a system 400 that can be utilized to more effectively facilitate inter-datacenter resource interchange between front end components included in a first cluster and associated with a first datacenter situated in a first geographical location and a server component included in a second cluster and associated with a second datacenter in a second geographic location, wherein each of the first and second geographical locations are geographically remote from one another. As illustrated, system 400 includes two clusters, cluster X 402, associated with a first datacenter situated in a first geographic location (e.g., Mississauga, Canada), and cluster Y 404, associated with a second datacenter situated in a second geographic location (e.g., Cancun, Mexico). As will be appreciated and observed by those of moderate skill in this field of endeavor, the first and second geographical locations can be both distantly dispersed as well as geographically distant. Thus, for example, the first datacenter situated in the first geographical location can merely be a short distance from the second datacenter situated in a second geographical location. For instance, the first datacenter can be located from a few meters from the second datacenter to many hundreds or thousands of kilometers from the second datacenter.

Cluster X 402 can include front end component 406 together with its associated lookup library 408 and partitioning and recovery manager component 208_{X} the respective functionalities and/or facilities of which have been expounded upon above in connection with FIGS. 1-3, and as such a detailed description of such features have been omitted. Nevertheless, in addition to the foregoing components, cluster X 402 can also include an inter-cluster gateway component 410_{X} that can facilitate and/or effectuate communication with a counterpart inter-cluster gateway 410_{Y} situated in Cluster Y 404 located at a geographically dispersed distance from cluster X 402.

Cluster Y 404 in addition to inter-cluster gateway component 410_{Y} also can include proxy component 412 that like front end component 406, can include an associated lookup library. Further, cluster Y 404 can also include the proto-typical partitioning and recovery manager component 208_{Y}, as will have been observed by those moderately skilled in this field of endeavor, that typically can be present in all clusters set forth in the claimed subject matter. Cluster Y 404 can further include server component 414 together with its owner library where the resource being sought by a client component (e.g., 202₁, . . . , 202_{A}) can be reposited.

In view of the foregoing components depicted in FIG. 4, the claimed subject matter can operate in the following manner. Initially, a remote resource request (e.g., the resource needed is persisted and associated with a server component located in a cluster associated with a geographically dispersed datacenter) from a client component can be received by front end component 406 situated in cluster X 402. On receipt of the resource request, front end component 406 is typically ignorant of the fact that the resource request pertains to a remotely reposited resource and thus can consult its associated lookup library 408. Lookup library 408, since the resource request at this point has never been satisfied before will be equally unaware of where and/or how the resource request can be fulfilled, and as such can utilize the facilities and/or functionalities of partitioning and recovery manager 208_{X} to obtain indication that the sought after resource included in the resource request is reposited in a cluster associated with a datacenter geographically distant from the cluster in which the resource request has been received. The cluster information returned from partitioning and recovery manager 208_{X} can then be utilized to populate the lookup library 408 with the received cluster information, after which front end component 406 can construct a message that includes the cluster information recently gleaned from partitioning and recovery manager component 208_{X}, together with the service or resource that is being requested from the server situated in the remote/destination cluster (e.g., cluster Y 404). The message so constructed by front end component 406 can then be conveyed to inter-cluster gateway component 410_{X} for dispatch to inter-cluster gateway component 410_{Y} associated and situated with the remote/destination cluster (e.g., cluster Y 404).

On receipt of the message from inter-cluster gateway component 410_{X}, inter-cluster gateway component 410_{Y} can examine the cluster information included in the message to determine that the message has both been received by the correct cluster in the correct geographically remote or destination datacenter. Having ascertained that the message has been received by both the correct cluster and the correct remote/destination datacenter, inter-cluster gateway component 410_{Y} can forward the message to proxy component 412 and its associated lookup libraries. It should be noted at this juncture that the operation of, and functions and/or facilities provided by proxy component 412 and its associated lookup libraries can be similar to those provided by front end component 406 and its associated lookup library 408.

Thus, when inter-cluster gateway component 410y passes the message received from inter-cluster gateway component 410_{X} situated in cluster X 402 to proxy component 412, proxy component 412 in conjunction with its associated libraries can ascertain which server 414 within clustery 404 is capable of fulfilling the resource request received from front end component 406 located in cluster X. In order to identify the appropriate server component 414 capable of fulfilling the remote resource request, proxy component 412 can employ its associated libraries to resolve who (e.g., which server component within cluster Y 404) is capable of handling or satisfying the remote resource request received from front end component 404 situated in cluster X 402 via inter-cluster gateway components 410_{X} and 410_{Y}. Once proxy component 412 has ascertained or determined the server component 414 capable of fulfilling the remote resource request, proxy component 412 can forward the remote request to server component 414 for satisfaction of the remote request.

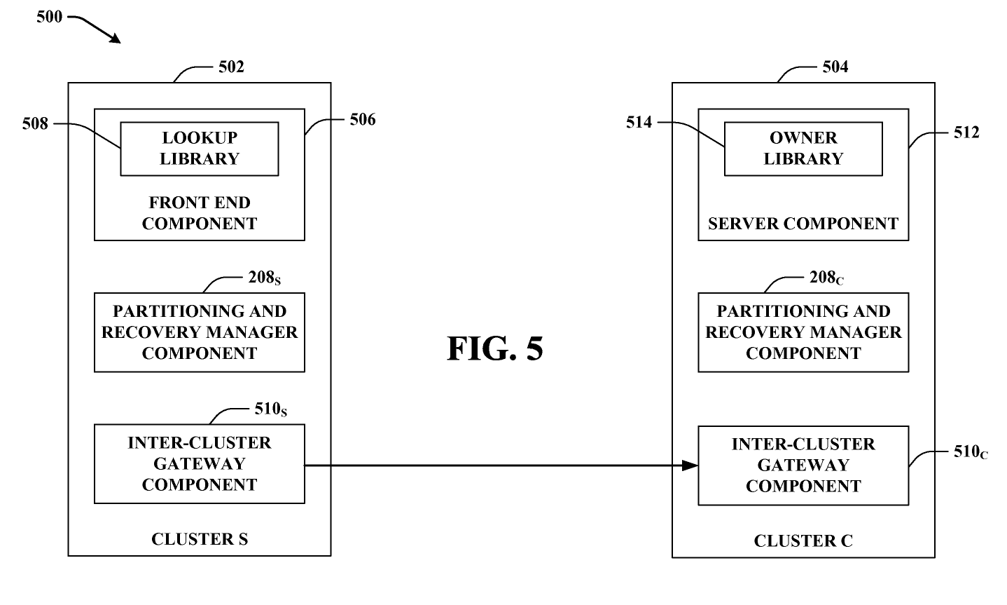

FIG. 5 provides depiction of a further system 500 that can be employed to facilitate and/or effectuate inter-datacenter resource interchange in accordance with an aspect of the claimed subject matter. As illustrated, system 500 includes two clusters, cluster S 502, associated with a first datacenter situated in a first geographic location (e.g., Selma, Ala.), and cluster C 504, associated with a second datacenter situated in a second geographic location (e.g., Copenhagen, Denmark). As will be appreciated and observed by those of moderate skill in this field of endeavor, the first and second geographical locations can be both distantly dispersed as well as geographically distant. Thus, for example, the first datacenter situated in the first geographical location can merely be a short distance from the second datacenter situated in a second geographical location. For instance, the first datacenter can be located from a few meters from the second datacenter to many hundreds or thousands of kilometers from the second datacenter.

Cluster S 502 can include front end component 506 together with its associated lookup library 508 and partitioning and recovery manager component 208_{S} the respective functionalities and/or facilities of which have been expounded upon above in connection with FIGS. 1-4, and as such a detailed description of such features have been omitted. Nevertheless, in addition to the foregoing components, cluster S 502 can also include an inter-cluster gateway component 510_{S} that can facilitate and/or effectuate communication with a counterpart inter-cluster gateway 510_{C} situated in Cluster C 504 located at a geographically dispersed distance from cluster S 502.

In view of the foregoing components depicted in FIG. 5, the claimed subject matter can operate in the following manner. Initially, a remote resource request (e.g., the resource needed is persisted and associated with a server component located in a cluster associated with a geographically dispersed datacenter) from a client component can be received by front end component 506 situated in cluster S 502. In contrast to the situated outlined in FIG. 4, here the front end component 506 can be aware of the server component 512 that has control or possession of the needed resource, but nevertheless can be unaware as to which cluster and/or datacenter in which server component 512 resides.

Thus, on receipt of the resource request, front end component 506 can consult its associated lookup library 508. Lookup library 508, can utilize the facilities and/or functionalities of partitioning and recovery manager 208_{S} to obtain indication that server component 512 that controls or handles the sought after resource included in the resource request is associated in cluster C associated with a datacenter geographically distant from the cluster in which the resource request has been received. Front end component 506 can thereafter construct an message that includes the cluster information recently gleaned from partitioning and recovery manager component 208_{S}, together with the identity of the destination or remote server (e.g., server component 512) that controls or handles the service or resource that is being requested. The message so constructed by front end component 506 can then be conveyed to inter-cluster gateway component 510_{S} for dispatch to inter-cluster gateway component 510_{C} associated and situated with the remote/destination cluster (e.g., cluster C 504). On receipt of the message from inter-cluster gateway component 510_{S}, inter-cluster gateway component 510_{C} can forward the message directly to server component 512 for satisfaction of the remote request.

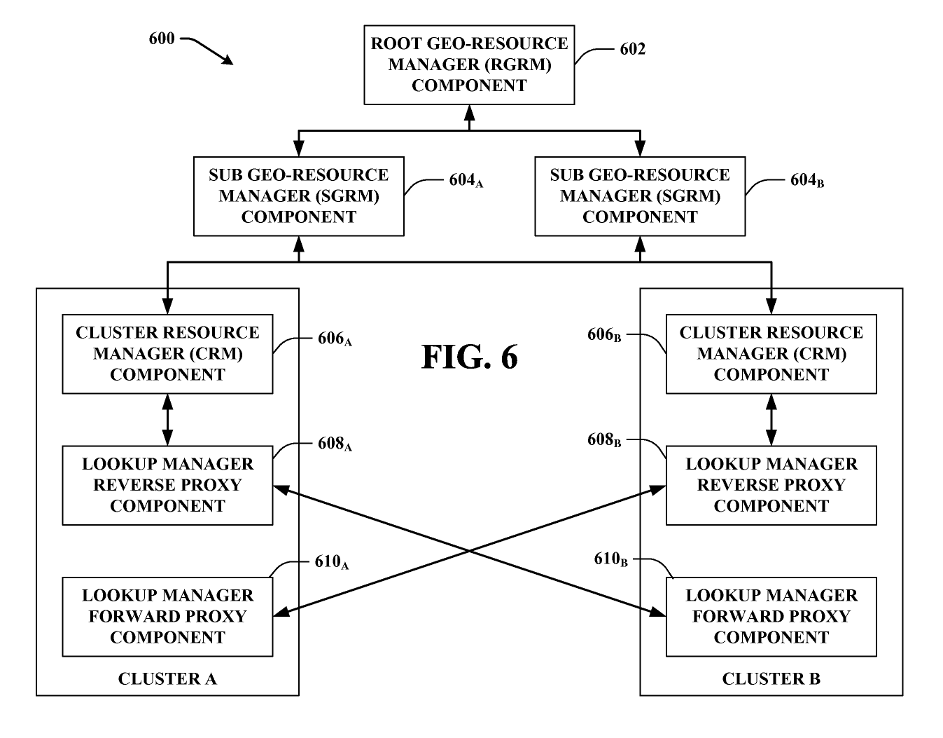

FIG. 6 provides further illustration of a system that can be utilized to effectuated and/or facilitate inter-datacenter resource interchange in accordance with a further aspect of the claimed subject matter. In particular, FIG. 6 depicts an architecture 700 that can be employed to enable inter-cluster interactions. There are two sets of design issues—ownership issues (e.g., resource assignments with respect to owners) and lookup/recovery notification issues—addressed by the architecture. The root geo-resource manager (RGRM) component 602, sub geo-resource manager (SGRM) components 604_{A} and 604_{B}, and an owner manager bridge associated with cluster resource manager (CRM) components 606_{A} and 606_{B} mostly help with the former, whereas the lookup manager forward proxies (LMFP) 610_{A} and 610_{B} and lookup manager reverse proxies (LMRP) 608_{A} and 608_{B} largely help in the latter case. The SGRM component, LMFP, and the LMRP are typically all scale-out components

Root geo-resource manager (RGRM) component 602 is a centralized manager that scales out the sub geo-resource manager components 604_{A} and 604_{B}. The sub geo-resource manager components 604_{A} and 604_{B} can hold resource assignments and then can delegate these assignments to individual local partitioning and recovery management components associated with local cluster resource manager (CRM) components 606_{A} and 606_{B}. The resource assignment to different local partitioning and recovery manager components can be done in an automated manner or using an administrative interface, for example.

Sub geo-resource manager component 604_{A} and 604_{B} can assign resources to global owners where each such owner runs in a cluster. This owner can be co-located in cluster resource manager (CRM) component 606_{A} and 606_{B} with a local partitioning and recovery manager that assigns resources to local owners. These two components can be connected by an owner manager bridge that can receive resources from a global owner and convey them to the local partitioning and recovery manager and can also handle the corresponding recalls from the global owner as well.

The motivation for dividing sub geo-resource managers 604_{A} and 604_{B} from the root geo-resource manager 602 is that the amount of state that might need to be maintained for mapping resource ranges to specific clusters can be many terabytes.

The lookup manager forward proxies 610_{A} and 610_{B} can handle lookup requests from local client components for remote clusters. Lookup manager forward proxies 610_{A} and 610_{B} can also handle incoming recovery notifications for local lookup nodes from remote clusters. The lookup manager forward proxies 610_{A} and 610_{B} helps in connection aggregation across clusters, e.g., instead of having many lookup nodes connect to remote cluster(s), only a few lookup manager forward proxies 608_{A} and 608_{B} need to make any connections per cluster. Furthermore, these lookup manager forward proxies 608_{A} and 608_{B} can be useful in aggregating a cluster's traffic.

One subtlety to note here is that when a server component (e.g., server component 512) crashes, the recovery notification comes from the cluster resource manager (CRM) components 606_{A} and 606_{B}, not from the sub geo-resource manager components 604_{A} and 604_{B}.

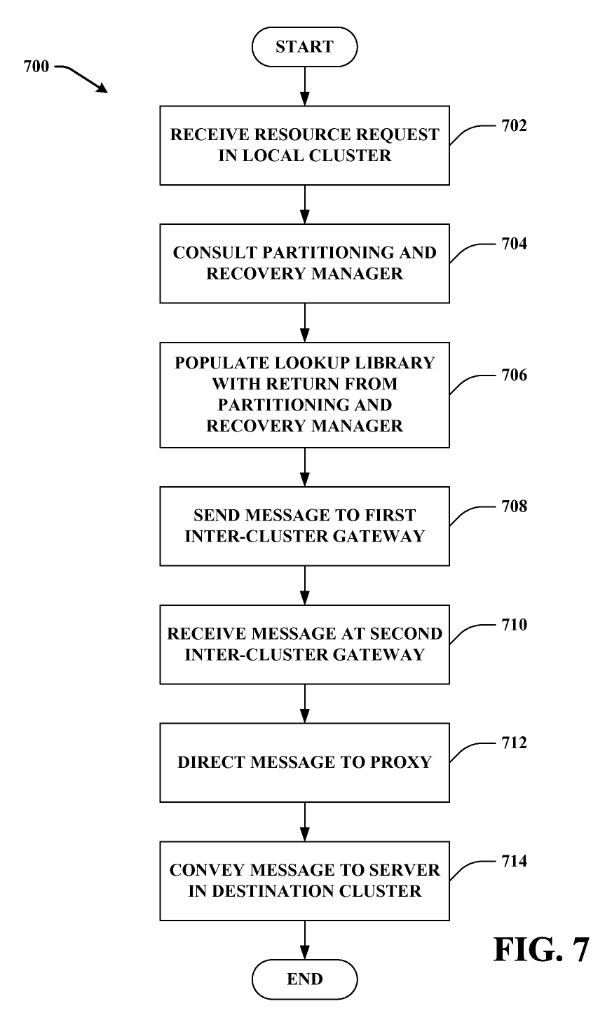

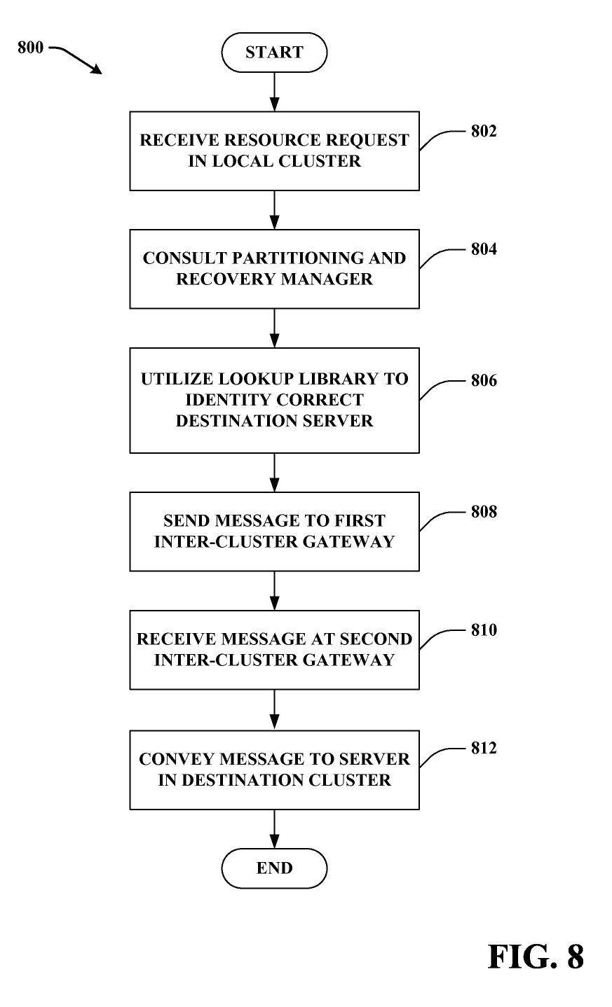

In view of the illustrative systems shown and described supra, methodologies that may be implemented in accordance with the disclosed subject matter will be better appreciated with reference to the flow charts of FIGS. 7-8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

The claimed subject matter can be described in the general context of computer-executable instructions, such as program modules, executed by one or more components. Generally, program modules can include routines, programs, objects, data structures, etc. that perform particular tasks or implement particular abstract data types. Typically the functionality of the program modules may be combined and/or distributed as desired in various aspects.

FIG. 7 illustrates a method to effectuate and/or facilitate inter-datacenter resource interchange in accordance with an aspect of the claimed subject matter. At 702 a resource request can be received by a front end component. At 704 the front end component can consult a partitioning and recovery manager aspect to ascertain the appropriate cluster information as to where the server component capable of fulfilling the received resource request is located. At 706 when the partition and recovery manager aspect responds with the appropriate cluster information the lookup library associated with the front end component can be populated with the returned information. At 708 the returned cluster information can be combined with the resource request and conveyed to a first inter-cluster gateway for dispatch to a second inter-cluster gateway associated with a remote cluster. At 710 the returned cluster information together with the resource request can be received at the second inter-cluster gateway and thereafter conveyed to a proxy component at 712. At 714, once the proxy component has ascertained the server that is capable of serving or fulfilling the resource request, the request can be conveyed to the identified server for servicing or fulfillment.

FIG. 8 depicts a further methodology to effectuate and/or facilitate inter-datacenter resource interchange in accordance with a further aspect of the claimed subject matter. At 802 a resource request can be received by a front end component. At 804 the front end component can consult a partitioning and recovery manager aspect to ascertain the appropriate cluster information as to where the server component capable of fulfilling the received resource request is located. At 806 when the partition and recovery manager aspect responds with the appropriate cluster information the lookup library associated with the front end component can be utilized to identify the correct destination server (e.g., a server affiliated with a cluster associated with a datacenter at a remote location). At 808 the returned cluster information together with the destination server information can be conveyed to a first inter-cluster gateway for dispatch to a second inter-cluster gateway associated with a remote cluster. At 810 the returned cluster information together with the resource request can be received at the second inter-cluster gateway and thereafter conveyed to the server that is capable of serving or fulfilling the resource request at 812.

The claimed subject matter can be implemented via object oriented programming techniques. For example, each component of the system can be an object in a software routine or a component within an object. Object oriented programming shifts the emphasis of software development away from function decomposition and towards the recognition of units of software called “objects” which encapsulate both data and functions. Object Oriented Programming (OOP) objects are software entities comprising data structures and operations on data. Together, these elements enable objects to model virtually any real-world entity in terms of its characteristics, represented by its data elements, and its behavior represented by its data manipulation functions. In this way, objects can model concrete things like people and computers, and they can model abstract concepts like numbers or geometrical concepts.

As used in this application, the terms “component” and “system” are intended to refer to a computer-related entity, either hardware, a combination of hardware and software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Furthermore, all or portions of the claimed subject matter may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

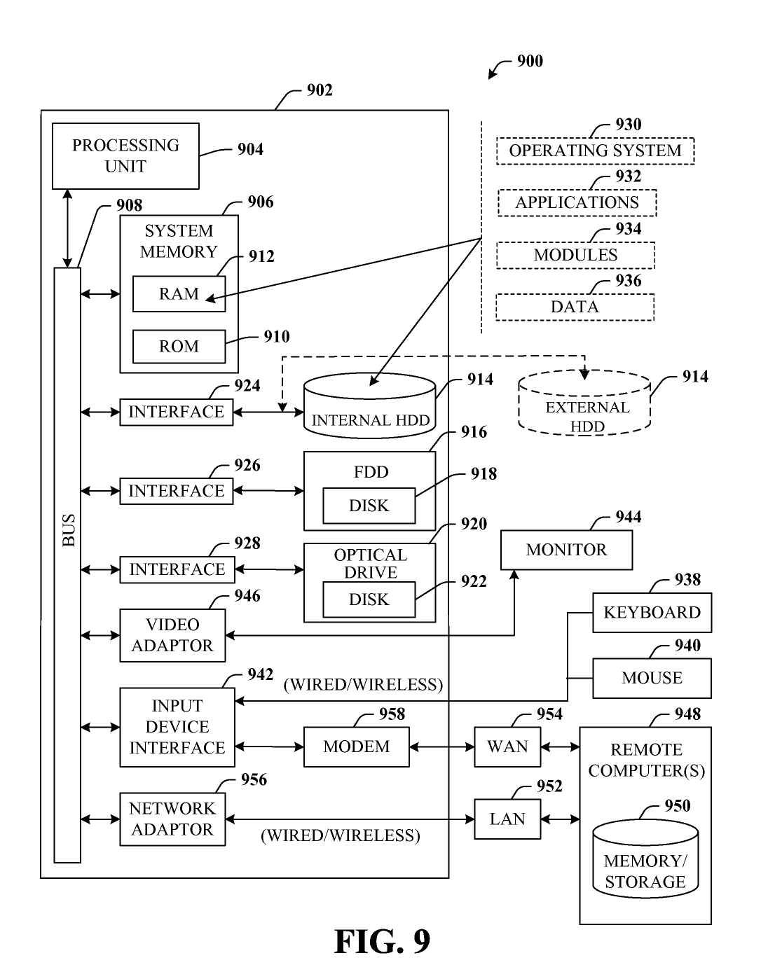

Referring now to FIG. 9, there is illustrated a block diagram of a computer operable to execute the disclosed system. In order to provide additional context for various aspects thereof, FIG. 9 and the following discussion are intended to provide a brief, general description of a suitable computing environment 900 in which the various aspects of the claimed subject matter can be implemented. While the description above is in the general context of computer-executable instructions that may run on one or more computers, those skilled in the art will recognize that the subject matter as claimed also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 9, the illustrative environment 900 for implementing various aspects includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1094 interface technologies. Other external drive connection technologies are within contemplation of the claimed subject matter.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the illustrative operating environment, and further, that any such media may contain computer-executable instructions for performing the methods of the disclosed and claimed subject matter.

A number of program modules can be stored in the drives and RAM 912, including an operating system 930, one or more application programs 932, other program modules 934 and program data 936. All or portions of the operating system, applications, modules, and/or data can also be cached in the RAM 912. It is to be appreciated that the claimed subject matter can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1094 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adaptor 956 may facilitate wired or wireless communication to the LAN 952, which may also include a wireless access point disposed thereon for communicating with the wireless adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are illustrative and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+Mbps in the 2.4 GHz band. Products can contain more than one band (e.g., dual band), so the networks can provide real-world performance similar to the basic 10 BaseT wired Ethernet networks used in many offices.

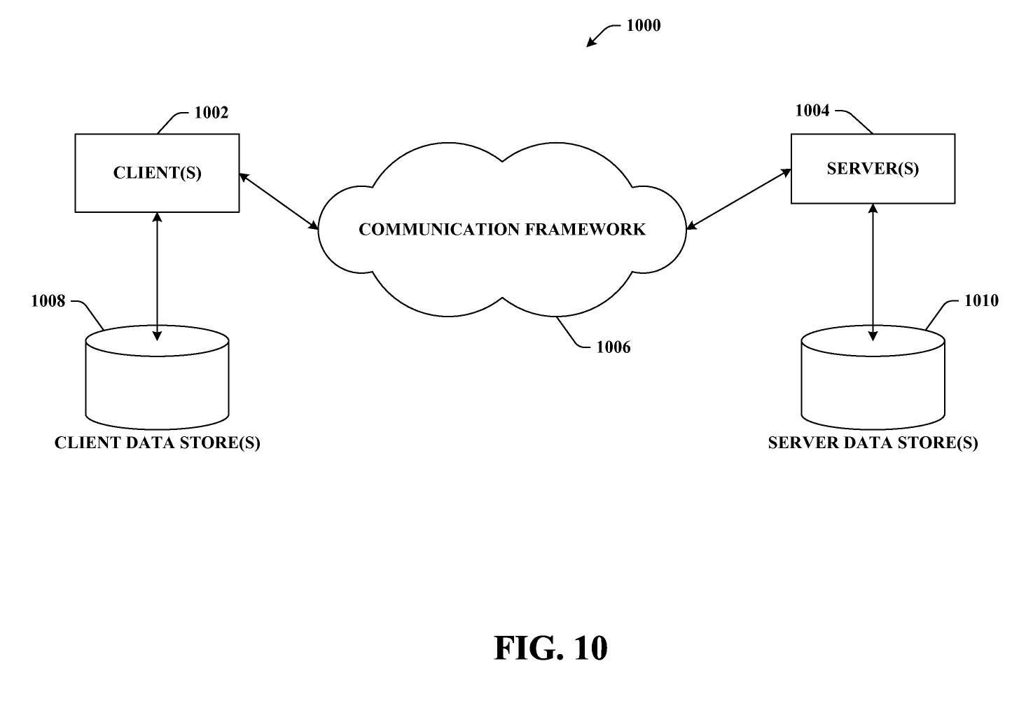

Referring now to FIG. 10, there is illustrated a schematic block diagram of an illustrative computing environment 1000 for processing the disclosed architecture in accordance with another aspect. The system 1000 includes one or more client(s) 1002. The client(s) 1002 can be hardware and/or software (e.g., threads, processes, computing devices). The client(s) 1002 can house cookie(s) and/or associated contextual information for example.

The system 1000 also includes one or more server(s) 1004. The server(s) 1004 can also be hardware and/or software (e.g., threads, processes, computing devices). The servers 1004 can house threads to perform transformations by employing the claimed subject matter, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the disclosed and claimed subject matter. It is, of course, not possible to describe every conceivable combination of components and/or methodologies, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A machine-implemented system that effectuates or facilitates inter-datacenter resource interchange, comprising the following computer executable components:
a frontend component that receives a resource request from a client component, the frontend component associating the resource request with a cluster identity associated with a remote datacenter based on a request to a management component, the resource request dispatched to the remote datacenter via an inter-cluster gateway component.

2. The system of claim 1, the inter-cluster gateway component consults a proxy component to determine a server component capable of servicing the resource request from the client component, the server component associated with the remote datacenter.

3. The system of claim 1, the frontend component, the client component, or the management component form a cluster associated with a first datacenter.

4. The system of claim 3, the remote datacenter and the first datacenter separated by geography.

5. The system of claim 3, the cluster includes the management component, the cluster controlled by a sub geo-resource manager, the sub geo-resource manager subservient to a root geo-resource manager.

6. The system of claim 1, the remote datacenter includes at least one cluster, the server included in the at least one cluster, the at least one cluster controlled by a sub geo-resource manager, the sub geo-resource manager subservient to a root geo-resource management.

7. The system of claim 1, the frontend component associated with a lookup library.

8. A method for effectuating inter-datacenter resource interchange, comprising:
receiving a resource request;
consulting a partitioning and recovery manager to identify a cluster and server in which the resource request resides; and
sending the resource request to a remote datacenter via an inter-cluster gateway associated with a datacenter.

9. The method of claim 8, further comprising using an inter-cluster gateway at the first cluster or the remote cluster.

10. The method of claim 9, further comprising directing the message from the inter-cluster gateway associated with the cluster directly to the server on which the resource is held.

11. The method of claim 8, the resource request received from a frontend component associated with a local cluster associated with the datacenter.

12. The method of claim 11, the datacenter and the remote datacenter connected via a trans-oceanic link.

13. The method of claim 12, a relative communications latency of communications between components included in the local cluster less than the relative communications latency of communications between the remote datacenter and the datacenter.

14. A system that effectuates or facilitates inter-datacenter resource interchange, comprising:
a processor configured for receiving a resource request from a client component, consulting a management component that returns an identity associated with a remote datacenter, and dispatching the resource request to the remote datacenter using the identity; and
a memory coupled to the processor for holding data.

15. The system of claim 14, the processor further configured for consulting a proxy component to determine a server component capable of servicing the resource request from the client component, the server component associated with the remote datacenter.

16. The system of claim 14, the client component, or the management component form a cluster associated with a first datacenter.

17. The system of claim 16, the cluster controlled by a sub geo-resource manager, the sub geo-resource manager controlled by a root geo-resource management.

18. The system of claim 16, the remote datacenter and the first datacenter separated by a geographical boundary.

19. The system of claim 14, the remote datacenter includes at least one cluster, a server included in the at least one cluster, the at least one cluster controlled by a sub geo-resource manager, the sub geo-resource manager subservient to a root geo-resource management.

20. The system of claim 19, the server associated with an owner library that has control over the resource requested by the resource request.
